(19) United States
(12) Patent Application Publication
(10) Pub. No.: US 2026/0350362 A1
(43) Pub. Date: Nov. 5, 2026

(54) CUSTOMIZING GENERATIVE MACHINE LEARNING MODEL OUTPUT

(71) Applicant: Adobe Inc., San Jose, CA (US)

(72) Inventors: Pritika RAMU, Karnataka (IN); Varsha Sankar, Mountain View, CA (US); Meghanath M Y, San Jose, CA (US); Debraj Debashish Basu, Sunnyvale, CA (US); Apoorv Umang Saxena, Bangalore (IN)

(21) Appl. No.: 19/195,421

(22) Filed: Apr. 30, 2025

(51) Int. Cl. G06N 3/0455; G06N 3/084

(52) U.S. Cl. CPC G06N 3/0455; G06N 3/084

(57) ABSTRACT

In various examples, a tone-adapted machine learning model is generated based on a training dataset to generate content that is representative of and/or otherwise includes a particular tone. For example, textual data generated to represent a particular identity, such as a brand or enterprise, is used to generate the training dataset by at least associating attributes of the tone with particular text segments. Continuing this example, a first machine learning model is trained with the dataset and merged with a second machine learning model to generate the tone-adapted machine learning model. Finally, in this example, the tone-adapted machine learning model generates content based on prompts that mimics or otherwise matches the tone represented in the training dataset.

### BACKGROUND

Various types of artificial intelligence (AI) models can be trained using various training techniques. For example, pre-training and fine-tuning are techniques used to improve the output generated by large language models (LLMs). One example of fine-tuning a trained large language model includes adjusting the LLM parameters (e.g., weights of the model) through techniques such as gradient descent, where the model is trained to minimize the difference between predictions generated by the LLM and training data. LLMs can be trained on a large corpus of data and extract or otherwise generate text-based answers to questions related to the large corpus of data. Furthermore, as mentioned above, the answers generated by the AI models can be improved with additional training techniques. However, these improved answers often fall short of providing answers or responses that convey a particular tone or manner of communicating.

### SUMMARY

Embodiments described herein are directed to enhancing and/or improving the output quality of large language models (LLMs) for content creation by training an LLM to generate outputs that align with a tone and/or manner of communicating. For example, particular brands and/or entities convey messages, marketing information, and/or other communications using a specific tone, format, or other means to convey a particular identity associated with the brand and/or entity. Continuing this example, marketers for a particular brand generate marketing campaigns that are consistent with the tone and messaging of the brand in order to establish a brand identity to attract customers and maintain customer expectations. In various embodiments, a pre-trained machine learning model is modified using various training techniques and a corpus of enterprise-specific data (e.g., marketing assets, communications, campaigns, etc.).

In various embodiments, brand and/or enterprise-level data is obtained that includes the tone, structure, and/or manner of communication that the machine learning model is trained to emulate or otherwise copy. In such embodiments, this data is stored in a data structure such as a key-value store or other data structure to enable the machine learning model to associate specific elements with attributes. In one example, marketing emails are stored in a data structure that includes keys corresponding to the subject line, the preheader, the headline, the body, the call to action, and/or other sections of the emails, where the values stored in the data structure correspond to the text included in emails.

In an embodiment, the data structure is used during pre-training of an LLM or other machine learning model. For example, training techniques such as gradient descent are used to adjust the LLM parameters such that the LLM generates outputs that include the tone and/or manner of communication represented in the data structure. In various embodiments, low-rank adaptation (LoRA) is used instead of unfreezing the LLM parameters. For example, the delta and/or change of the LLM parameters (e.g., model weights) is determined during pre-training. In such embodiments, the LoRA adapter generated during pre-training is merged with a new machine learning model such as an instruction fine-tuned LLM to generate a tone-adapted machine learning model that generates outputs including the unique stylistic attributes, tone, and mannerisms represented in the data structure (e.g., the brand and/or entity).

In addition, in an embodiment, guided decoding is used to enable the tone-adapted machine learning model to generate specific content. In one example, a specific schema for emails and/or other communications is used to ensure that the output of the tone-adapted machine learning model conforms to a specific format (e.g., subject line, preheader, body, conversational message, answer response, etc.). In various embodiments, as a result of these training techniques, the tone-adapted machine learning model generates content that is aligned with a tone and manner of communication (e.g., a brand identity), significantly improving outputs generated by machine learning models.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced.

FIG. 2 depicts an environment in which an adapted machine learning model generates an output based on a prompt, in accordance with at least one embodiment.

FIG. 3 depicts an environment in which a data structure is generated that includes a training dataset, in accordance with at least one embodiment.

FIG. 4 depicts an environment in which a schema is defined for guided decoding using the adapted machine learning model, in accordance with at least one embodiment.

FIG. 5 depicts an example process flow for generating a training dataset, in accordance with at least one embodiment.

FIG. 6 depicts an example process flow for training an adapted machine learning model, in accordance with at least one embodiment.

FIG. 7 depicts an example process flow for generating an output using an adapted machine learning model, in accordance with at least one embodiment.

FIG. 8 is a block diagram of a Large Language Model that uses particular inputs to make particular predictions, according to some embodiments.

FIG. 9 is a block diagram of an exemplary computing environment suitable for use in implementations of the present disclosure.

### DETAILED DESCRIPTION

Various terms are used throughout the description of embodiments provided herein. A brief overview of such terms and phrases is provided here for ease of understanding, but more details of these terms and phrases is provided throughout.

“Tone” refers to the specific stylistic attributes, mannerisms, word choice, and/or emotion that characterize the way content is communicated, encompassing elements like vocabulary, sentence structure, voice, mood, and engagement. Examples of tone include writing styles that embody a particular identity (e.g., person or entity). Tone can be extracted from textual data included in content and stored in a training dataset to be used to train a tone-adapted large language model (LLM) for content creation. For example, the tone can be extracted using historical, enterprise-approved marketing assets, ensuring that the tone-adapted machine learning model captures a brand's unique identity, resulting in hyper-personalized, high-quality content providing a more efficient and personalized solution for content creation.

“Content” refers to the information and experiences directed towards an end-user or audience. Examples of content include documentation, training material, instructions, marketing campaigns, phrases, emails, or other textual data. In one example, the content includes marketing assets such as emails and the components of the emails including subject lines, preheaders, headlines, bodies, and calls to action, which are generated to align with the brand's unique voice and style. Content can include any textual data that can embody or otherwise be used to determine a tone associated with a particular identity, such as a brand, enterprise, or individual. Furthermore, the content is used to generate training datasets which can be used to train machine learning models to generate outputs that include the specific tone reflected in the content.

“Schema” refers to a structured framework or structure data object that defines the organization and format of a training dataset or machine learning model output during guided decoding. In one example, a schema is used to format marketing assets into key-value pairs, ensuring that each component of the content (e.g., subject line, preheader, body) is systematically represented for effective model training. Continuing this example, the schema defines the relationship between segments and/or components of content and the tone embodied or otherwise represented in the content. In this manner, the structured data provided by the schema enables a machine learning model to modify an internal state of the machine learning model (e.g., parameters, weights, etc.) and replicate the tone embodied or otherwise represented in the content. Furthermore, in another example, the schema defines the output generated by machine learning models. In this manner, the schema defines constraints and/or other requirements corresponding to tokens outputted by the machine learning model. In one example, a schema is defined to format the content generated by the machine learning model such that the schema constrains or otherwise limits the possible tokens generated by the machine learning model to achieve a particular result, such as generating an email or other formatted communication.

“Training dataset” is a collection of data used to train a machine learning model. In one example, the training data set consists of labeled examples that the machine learning model learns from (e.g., one or more training technique are used to cause the machine learning model to update model parameters) to generate inferences and/or make predictions. Furthermore, in some examples, a schema defines the format for labeling the examples to generate the training dataset. In addition, the training dataset can include textual data that is extracted from the content (e.g., marketing assets) and structured based on the schema. In this manner, the training dataset is structured to enable a machine learning model to associated attributes of tone such as structure, voice, word choice, and manner of communication with specific components (e.g., text segments) of the content. In addition, the training dataset can be generated in a structure format such as JavaScript Object Notation (JSON) or Comma-Separated Values (CSV) to enable the association between text segments and the corresponding attribute and/or role.

“Pre-trained machine learning model” refers to a machine learning model that has been previously trained on a large corpus of data to learn general patterns and representations. In various examples, the pre-trained machine learning model serves as a foundation for further fine-tuning on specific tasks or domains, leveraging existing knowledge to improve performance. Continuing this example, the pre-trained machine learning model is used to build more specialized machine learning models such as the tone-adapted machine learning model through additional training. Some examples of pre-trained machine learning model are Open Pre-trained Transformer (OPT), Bidirectional and Auto-Regressive Transformers (BART), GOOGLE's Bidirectional Encoder Representations from Transformers (BERT), and OpenAI's Generative Pre-trained Transformer (GPT)

“Instruction fine-tuned machine learning model” refers to a pre-trained model that has been further trained to follow specific instructions or prompts. Generating an instruction fine-tuned model involves gathering a labeled dataset of instructional prompts and outputs, then fine-tuning a pre-trained machine learning model using gradient descent and/or other optimization algorithms to adjust its parameters. The instruction fine-tuned model can be evaluated and refined iteratively to ensure it follows instructions accurately. In one example, the fine-tuning process enhances the ability of the instruction fine-tuned machine learning model to generate responses that adhere to given guidelines, making it more effective for tasks requiring precise instructions. This Instruction fine-tuned machine learning model is adapted to execute specific tasks based on the provided instructions. Some examples include GPT-3.5-turbo, Large Language Model Meta AI 2-chat (Llama-2-chat), Code Llama, Fine-tuned Language Net—Text-To-Text Transfer Transformer (FLAN-T5), and Chat GPT.

“Tone-adapted machine learning model” refers a machine learning model that has been trained to generate content that embodies or otherwise represents a particular tone. For example, the tone-adapted machine learning model is an instruction fine-tuned machine learning model that has been further trained to reflect the tone (e.g., unique stylistic attributes of a specific identity). Continuing this example, the tone-adapted machine learning model ensures that the generated content is hyper-personalized and deeply aligned with the specific identity (e.g., brand, enterprise, individual), improving over generic models. In one example, the tone-adapted machine learning model is trained using a corpus of enterprise-specific data to capture a brand's unique tone and generate content that matches the tone when executing tasks the require specific instructions. Continuing this example, the tone-adapted machine learning model is tasked with generating marketing content for a particular service, directed at a specific audience, and designed to trigger engagement with the audience.

“Guided decoding” refers to a technique used during text generation to control and enhance the quality of an output generated by the tone-adapted machine learning model. In one example, guided decoding involves incorporating constraints, external knowledge, and reward mechanisms to ensure that the generated text adheres to specific requirements, such as maintaining coherence, relevance, and alignment with the desired tone, format, and/or structure. This process improves the output generated by the tone-adapted machine learning model and ensures that the generated content conforms to a specific format and/or meets predefined standards. In one example, guided decoding is used to ensure that an email generated by the tone-adapted machine learning model conforms to the structure and format of emails as well as the tone of a particular identity.

“Low-Rank Adaptation” (LoRA) refers to a method for efficiently fine-tuning large language models by training low-rank matrices to adapt the parameters. This approach allows for parameter-efficient updates without modifying the entire model, making the fine-tuning process more computationally efficient while retaining high performance. In one example, LoRA is used to adjust the instruction fine-tuned machine learning model's parameters to generate the tone-adapted machine learning model such that the tone-adapted machine learning model better aligns with the desired output characteristics (e.g., tone). Furthermore, in some examples, the LoRA is generated based on the pre-trained machine learning model using the training dataset to train and/or fine-tune the pre-trained machine learning model.

In modern computing environments, users have access to various generative artificial intelligence (AI) tools to help process, digest, understand, query, or otherwise interact with and generate content such as documents, communications, campaigns, images, and other texts. For example, new tools including machine learning models, such as large language models (LLMs), are trained and used as AI assistants to enable users to interact with the LLMs and perform various operations. In particular, AI marketing tools can generate content but rely on broadly trained models or user-provided templates, limiting various domain-specific aspects such as personalization, creativity, and/or originality. In particular, the broadly trained AI tools are too generalized and fail to generate suitable content for various precise instruction based task.

As a result, conventional AI tools produce generic outputs with variable quality, limited personalization, and require additional refinement that is often time consuming and eliminates the efficiency benefits provided by conventional AI tools. Furthermore, these conventional AI tools include complex interfaces that increase the challenges when attempting to produce specific results. For example, tasks that require precise instructions often require technical expertise in prompt engineering and/or require a complex set of operations performed through an interface to obtain a result. In general, the generic outputs generated by conventional systems are particularly challenging in specific use cases and/or domains such as customer support, training, education, marketing, etc., where the information is to be conveyed with a specific tone and/or voice. For example, enterprise and/or brand communications are associated with a specific identity that includes various components such as tone, manner of speech, word choice, stylistic attributes, etc.; however, the generic outputs of conventional systems fail to capture this specific identity.

Furthermore, while some conventional systems can offer some refinements, as mentioned above, these refinements are difficult for users to implement and the level of personalization is limited and still requires additional refinements. These refinements aim to modify certain attributes of text while preserving the original content. However, these approaches merely alter surface-level stylistic elements of generated content but fail to capture the comprehensive characteristics required for effective use. For example, adhering to brand principles requires incorporation of additional attributes such as a brand's vocabulary, domain knowledge, and consistent tone across various tasks, which these techniques fail to incorporate. Furthermore, other techniques that rely on prompting (e.g., few-shot prompting) the conventional AI tools with specific instructions and/or examples can lead to over-fitting and can struggle to process new tasks. In addition, these prompting techniques are constrained by prompt length limitations of conventional AI tools and the in-context learning abilities of the specific model. The generalized models of conventional AI tools fail to accurately capture tone and/or identify information, which can limit these tools use and effectiveness in domain specific tasks that require precise instructions such as customer support, marketing, and communications.

In contrast, embodiments described herein include a tone-adapted machine learning model tool that utilizes various improved training techniques, described in detail below, to generate hyper-personalized outputs that are deeply aligned with brand identity and tailored to industry-specific requirements. For example, the tone-adapted machine learning model tool fine-tunes and adapts various machine learning models to enhance content quality and efficiency. Continuing this example, the adapted machine learning models (e.g., machine learning models trained by the tone-adapted machine learning model tool) generate content that is more engaging, inviting, and human-like, closely mimicking a brand's unique voice and tone. Furthermore, in various embodiments, the adapted machine learning models also significantly reduce the manual effort required for prompt engineering and content refinement, streamlining the content creation process. As a result, the adapted machine learning models, for example, can be used to perform various operations, including new content generation, conversational editing, and/or chatbots, providing consistent brand-aligned outputs across different platforms and/or communications. By leveraging these technical advancements, the tone-adapted machine learning model tool and resulting adapted machine learning models address various issues including creativity bottlenecks, thereby enabling enterprises to produce high-quality, brand-consistent content efficiently and effectively.

Accordingly, embodiments described herein generally relate the tone-adapted machine learning model tool. In operation, a training dataset is generated that includes key-value pairs that associate text segments with specific roles and/or attributes. Such a training data set is used to pre-train a candidate machine learning model to generate a low-rank adaptation (LoRA) adapter. Thereafter, the LoRA adapter is applied to a second machine learning model (e.g., an instruction fine-tuned version of the candidate model) by merging the model weights to generate an adapted machine learning model. Guided decoding is performed to ensure the output generated by the adapted machine learning model conforms to the structure and tone desired. In this regard, the systems and methods described are directed to an adapted machine learning model (e.g., a trained LLM) that generates outputs that are highly predictable and deterministic in manner, which conform to a particular tone and/or manner of speech desired by the user, including brand and/or enterprise-level speech.

Embodiments of the technical solution can be explained by way of examples with reference to an AI assistant (e.g., a chatbot or other interface integrated into an application) that provides users with access to the tone-adapted machine learning model that generates content capturing, embodying, or otherwise including a specific tone. In this way, the AI assistant and/or tone-adapted machine learning model is used to generate various types of high-quality content, relative to other broadly trained models, that require less effort and expertise to generate (e.g., using prompt engineering or other prompting techniques) and less editing and/or refinement of the generated content. For example, the AI assistant and/or tone-adapted machine learning model encodes brand-specific attributes such as tone and word choice into the tone-adapted machine learning model, ensuring that the generated content (e.g., the output of the adapted machine learning model) is brand-customized creative content suitable for enterprise-level tasks and/or domains.

In various embodiments, the adapted machine learning model tool generates marketing content tailored to a specific brand that mimics the personality, voice and tone, mannerisms, and verbiage used by an enterprise and/or brand in published content including emails, meta-ads, marketing campaigns, and other content. To do so, the adapted machine learning model tool processes a collection of documents (e.g., emails, meta-ads, marketing campaigns, chat logs, tutorials, published content, and other content, etc.) and generates a data structure that associates text snippets with specific roles and/or attributes. In one example, the data structure includes a key-value store that includes keys for components of an email (e.g., header, preheader, body, subject line, call to action, etc.) and the corresponding text snippets extracted from emails transmitted by the brand and/or generated during a marketing campaign. In various embodiments, the data structure is stored in a repository and used to train or otherwise generate the tone-adapted machine learning model. For example, the data structure is used to train and/or fine-tune a machine learning model, such as an LLM (e.g., a pre-trained text embedding model).

In various embodiments, a pre-trained machine learning model is further pre-trained and/or fine-tuned based on the data structure to adjust the parameters of the pre-trained machine learning model to encode the brand-specific tone represented in the data structure. For example, gradient descent is performed in a self-supervised manner to modify the pre-trained machine learning model state to be aligned with a curated corpus of documents stored in the data structure. In addition, in various embodiments, the changes to the pre-trained machine learning model parameters are obtained and used to further train and/or modify a second model to generate the tone-adapted model. In one example, a LoRA is trained, which represents a delta and/or change in model weights instead of unfreezing the pre-trained machine learning model.

In an embodiment, a second machine learning model such as an instruction fine-tuned model (e.g., an adaptation of the pre-trained machine learning model) is merged or otherwise trained using the LoRA. Returning to the example above, the LoRA adapter is merged with the second machine learning model systematically to generate the tone-adapted machine learning model. In addition, in various embodiments, to further ensure that the content of the tone-adapted machine learning model achieves the desired result, guided decoding is used during content generation. In one example, a specific schema, regular expression, and/or sampling constraint is used to ensure that tokens generated by the tone-adapted machine learning model during output generation conform to an expected format and/or structure. In an embodiment, the keys from the data structure used to train the pre-trained machine learning model are used during guided decoding. Returning to the example above, keys correspond to the components of an email (e.g., header, preheader, body, subject line, call to action, etc.), ensuring that the output of the tone-adapted machine learning model generates content in the expected format (e.g., an email).

Advantageously, embodiments described herein enable the generation of content, such as creative content, that matches a specific tone and/or attributes of an entity such as a brand and/or enterprise. For example, marketing content, such as emails and meta-ads, are generated that inherently match the tone of a specific brand, reducing manual effort and providing user-friendly implementation. In addition, in various embodiments, the generated content consistently includes unique stylistic attributes, tone, and mannerisms of the brand, resulting in hyper-personalized content that is deeply aligned with the brand's identity. As a result, in such embodiments, the generated content requires minimal manual refinement, and this efficiency significantly reduces the time and effort needed for prompt engineering and content refinement, streamlining the content creation process.

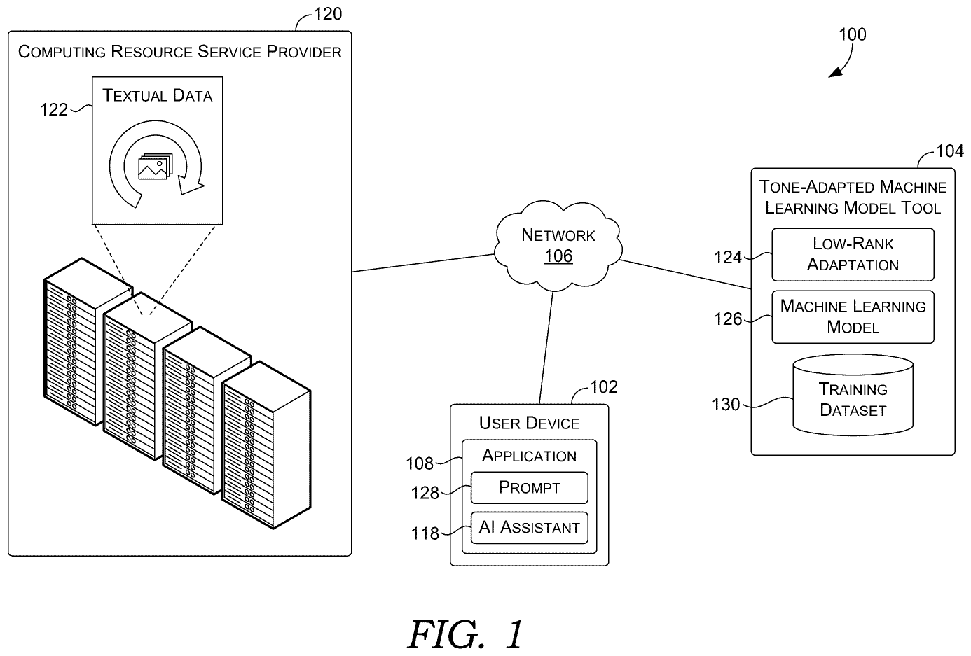

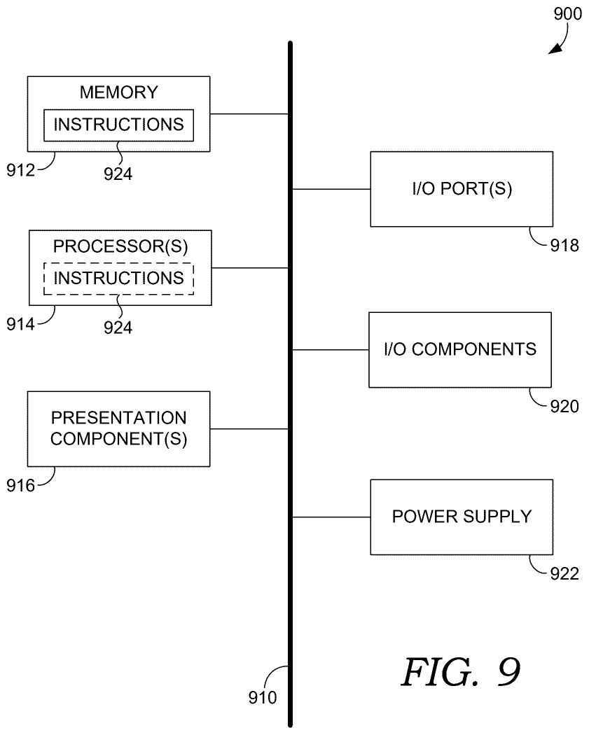

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 9.

It should be understood that operating environment 100 shown in FIG. 1 is an example of one suitable operating environment. Among other components not shown, operating environment 100 includes a user device 102, a tone-adapted machine learning model tool 104, computing resource service provider 120, and a network 106. Each of the components shown in FIG. 1 can be implemented via any type of computing device, such as one or more computing devices 900 described in connection with FIG. 9, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the tone-adapted machine learning model tool 104 includes multiple server computer systems cooperating in a distributed environment to perform the operations described in the present disclosure.

User device 102 can be any type of computing device capable of being operated by an entity (e.g., individual or organization) and that obtains data from tone-adapted machine learning model tool 104 and/or a datastore, which can be facilitated by the computing resource service provider 120 (e.g., a server operating as a frontend for the datastore). The user device 102, in various embodiments, has access to or otherwise maintains an artificial intelligence (AI) assistant, which provides an interface or otherwise includes a machine learning model 126 provided by the tone-adapted machine learning model tool 104. For example, the application 108 includes an analytics and/or marketing application that includes the AI assistant 118 that accepts a prompt 128 for the user to perform various tasks. Continuing this example, the prompt 128 includes a request to generate content that matches or otherwise mimics a particular tone represented in training data 130. In various embodiments, as described above, a particular brand and/or enterprise has a particular identity that includes various attributes including tone, word choice, manner of speech, and/or other stylistic attributes. Furthermore, the machine learning model 126, in an embodiment, is trained and/or otherwise adapted to generate content, based on the prompt 128, that matches the particular brand's tone. In addition, although some embodiments are directed at mimicking a particular brand's tone, other writing styles and/or entities can be mimicked—for example, the tone of a particular author, a particular writing style, or any other tone that can be represented or otherwise captured in text.

In some implementations, user device 102 is the type of computing device described in connection with FIG. 9. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102, computing resource service provider 120, and/or the tone-adapted machine learning model tool 104. For example, the application 108 allows users to create marketing material facilitated by the computing resource service provider 120 and the tone-adapted machine learning model tool 104. Furthermore, in various embodiments, the tone-adapted machine learning model tool 104 is provided by the computing resource service provider 120 (e.g., as a service). In some implementations, the application 108 comprises a web application, which can run in a web browser, and can be hosted at least partially on the server side of the operating environment 100. In addition, or instead, the application 108 can comprise a dedicated application, such as an application being supported by the user device 102 and the tone-adapted machine learning model tool 104. In some cases, the application 108 is integrated into the operating system (e.g., as a service). It is therefore contemplated herein that “application” be interpreted broadly. Some example applications include ADOBE® Customer Journey Analytics, a cloud-based analytics service.

For cloud-based implementations, for example, the application 108 is utilized to interface with the functionality implemented by the tone-adapted machine learning model tool 104. In some embodiments, the components, or portions thereof, of the tone-adapted machine learning model tool 104 are implemented on the user device 102 or other systems or devices. Thus, it should be appreciated that the tone-adapted machine learning model tool 104, in some embodiments, is provided via multiple devices arranged in a distributed environment that collectively provide the functionality described herein. Additionally, other components not shown can also be included within the distributed environment.

As illustrated in FIG. 1, a user, through the user device 102, submits the prompt 128 to the AI assistant 118 to cause the machine learning model 126 to generate content. For example, the user prompts the machine learning model 126 to generate creative marketing content for a product or service. In other examples, the prompt 128 includes a query and/or help-related question. As mentioned above, in various embodiments, the AI assistant 118 includes a chatbot or other user interface element that allows the user to submit queries. For example, the user can submit queries related to the application 108 such as “how do I save my work.” In other examples, the queries are related to a service provided such as “track my package.”

In some embodiments, the AI assistant 118 is operated by the computing resource service provider 120 and accessed through the application 108. For example, the application 108 includes a web browser that is used to access the application as a service and/or web page providing access to the AI assistant 118 and/or the tone-adapted machine learning model tool 104. For example, the user, through the application 108, provides the tone-adapted machine learning model tool 104 with access to training data 130 including the tone (e.g., data including style, tone, manner of speech, word choice, sentiment, and/or other attributes) the machine learning model 126 is to mimic. As described in greater detail below, in various embodiments, the training data 130 is used by the tone-adapted machine learning model tool 104 to modify an internal state of the machine learning model 126 to represent the statistics of past approved content (e.g., marketing material) while maintaining open-ended original instruction-following abilities of the machine learning model 126.

In various embodiments, the tone-adapted machine learning model tool 104 generates the training data 130 by obtaining or otherwise accessing textual data 122 including documentation, training material, marketing material, chat logs, emails, or other content that represents or otherwise includes tone information. In one example, the textual data 122 includes a web page or a website maintained or otherwise provided by the computing resource service provider 120. In another example, the textual data 122 includes emails such as marketing emails generated by the user and distributed to customers using computing resources of the computing resource service provider 120.

In various embodiments, the tone-adapted machine learning model tool 104 utilizes a schema or other structure to generate the training data 130. For example, key-value pairs are used to associate particular text snippets with a role and/or attribute included in the tone. In various embodiments, the training dataset 130 is generated in a structure format such as JavaScript Object Notation (JSON) or Comma-Separated Values (CSV). For example, the structured format includes labels for text snippets. Continuing this example, if the task of the machine learning model 126 is to generate marketing content, the dataset might include historical marketing assets with key-value pairs representing subject lines, preheaders, headlines, body sections, and calls to action.

In various embodiments, the training data 130 includes text that represents or otherwise includes a specific tone, where the specific tone is defined by various attributes of the text such as word usage, conciseness, how to address topics (e.g., products, plans, services, etc.), relative saliency of different portions of the text, repetition, and/or other factors. For example, the tone represented by the training data comprises the natural, inherent writing styles and preferences that characterize text. Continuing this example, the tone can include aspects and/or attributes of a brand and/or enterprise identity embodied in the text generated by the brand and/or enterprise.

In various embodiments, the prompt 128 includes natural language instructions for the machine learning model 126 to perform a specific task, where the task corresponds to a response domain that has been adapted for containing a response corresponding to the issued prompt 128. For example, given the prompt “generate a marketing email for the new feature in our product,” the machine learning model 126 generates content from the response domain that has been adapted (e.g., based on training the machine learning model 126) from the tone represented in the training dataset 130. In various embodiments, the weights and/or parameters of the machine learning model 126 are modified during training, as described below, based on the training dataset 130.

In various embodiments, the AI assistant 118 includes or has access to any number of machine learning models or technologies such as the machine learning model 126. In some embodiments, the AI assistant 118 includes, or accesses, a large langue model (LLM) that takes, as an input, a prompt, and provides, as output, content matching the tone based on the input. A language model is a statistical and probabilistic tool that determines the probability of a given sequence of words occurring in a sentence (e.g., via Next Sentence Prediction [NSP] or Masked Language Modeling [MLM]). In this way, it is a tool that is trained to predict the next word in a sentence. A language model is called a large language model when it is trained on an enormous amount of data. Some examples of LLMs are Open Pre-trained Transformer (OPT), Fine-tuned Language Net—Text-To-Text Transfer Transformer (FLAN-T5), Bidirectional and Auto-Regressive Transformers (BART), GOOGLE's Bidirectional Encoder Representations from Transformers (BERT), and OpenAI's Generative Pre-trained Transformer (GPT), GPT-3, and GPT-4. For instance, GPT-3 is a large language model with 175 billion parameters trained on 570 gigabytes of text. These models have capabilities ranging from writing a simple essay to generating complex computer codes—all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities. As described, in some embodiments, the AI assistant 118 and/or machine learning model 126 takes on the form of an LLM, but various other machine learning models can additionally or alternatively be used. Although various embodiments describe the use of an LLM, other language models (e.g., a small language model and/or a medium language model) can be used in connection with the embodiments described.

In embodiments, the AI assistant 118 and/or machine learning model 126 is fine-tuned. Fine-tuning generally refers to the process of retraining a pre-trained model on a new dataset (e.g., the training dataset 130) without training from scratch. Fine-tuning typically takes weights of a trained model and uses those weights as the initialization value, which is then adjusted during fine-tuning based on the new dataset. Fine-tuning can be used in cases in which an industry-specific dataset exists that can be used to fine-tune the model. In some implementations, the LLM is fine-tuned on various examples to leverage its text generation ability in association with particular types of data stored by the computing resource service provider 120—for example, generating meeting insights based on emails, meeting transcripts, and/or documents.

In various embodiments, a low-rank adaptation (LoRA) 124 is generated during fine-tuning operations on the AI assistant 118 and/or machine learning model 126. In one example, a pre-trained LLM, such as GPT-3, is selected as the base model, and the LoRA 124 adapter is initialized with two low-rank matrices, A and B, which represent the parameter updates. In some embodiments, the matrices A and B are smaller than the full parameter set of the LLM, making the fine-tuning process more efficient. In addition, in some embodiments, the rank of the matrices A and B is configured based on trade-off between computational efficiency and model performance.

In various embodiments, the LoRA 124 adapter is generated by using gradient descent to update the low-rank matrices A and B, while the base model's parameters remain fixed. For example, a loss function, such as cross-entropy loss for language modeling tasks, measures the difference between the predictions generated by the model (e.g., the pre-trained LLM) and the actual target values in the training dataset 130. In an embodiment, an optimization algorithm (e.g., Stochastic Gradient Descent [SGD]) is used to minimize the loss function and update the parameters of the LoRA 124 adapter. For example, if the model is being fine-tuned to generate customer support responses, the training dataset might include examples of high-quality support interactions.

In various embodiments, once the fine-tuning and/or training is complete, the LoRA 124 adapter is integrated with the machine learning model 126 by applying the low-rank matrices A and B to the parameters of the machine learning model 126. In an embodiment, the machine learning model includes an instruction fine-tuned (IFT) model that is the same version of the base model selected during the fine-tuning operations. For example, if the pre-trained GPT-3 model is selected and used to generate the LoRA 124 adapter, then the IFT GPT-3 model is merged with the LoRA 124 adapter to generate the machine learning model 126. In various embodiments, the machine learning model 126 is evaluated on a validation dataset to ensure the content generated by the machine learning model 126 includes the tone. In addition, in some embodiments, hyperparameters, such as learning rate and batch size, are adjusted to optimize the training process and improve model performance.

The output generated by an LLM (e.g., the machine learning model 126) may take on any number of forms. As one example, the output may include an email that includes the tone associated with a brand's identity in a way that resonates with a particular set of users (for instance, in a manner that captures the appeal of the brand to the set of users). As another example, the output may include a customer service response to the prompt 128 that provides the user with information that matches the tone of an enterprise.

In general, the AI assistant 118, in various embodiments, is integrated into the application 108 and provides productivity and creativity assistance through the machine learning model 126. In addition, in various embodiments, the application 108 and/or AI assistant further refines the output of the machine learning model 126 by implementing guided decoding. Returning to the example above, given the prompt “generate a marketing email for the new feature in our product,” a guided decoding process with a schema defining the email is used to further refine the output generated by the machine learning model 126. In addition, the AI assistant 118 provides a conversational setting for iterating over content in multiple rounds. Continuing the example above, the AI assistant 118 provides an interface to display a draft of the email generated by the machine learning model 126 and obtain additional prompts from the user further refining and/or improving the output generated by the machine learning model 126.

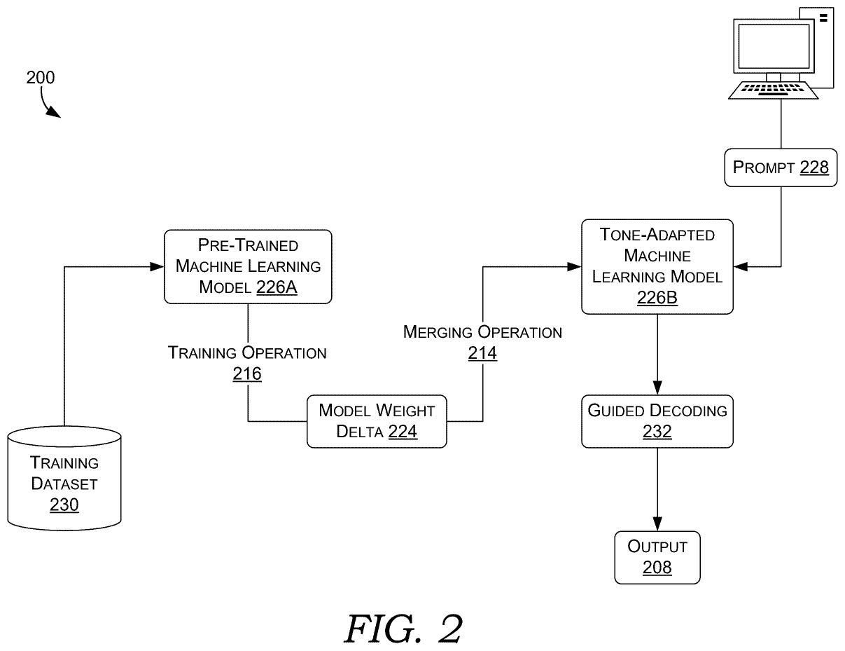

FIG. 2 shows an environment 200 in which a tone-adapted machine learning model 226B is generated that produces an output 208 that encodes or otherwise mimics a particular tone in accordance with at least one embodiment. For example, as described above, the adapted machine learning model 226B is trained or otherwise modified (e.g., modifying the parameters and/or weights of the adapted machine learning model 226B) to generate content (e.g., the output 208), such as marketing materials, that matches a particular tone represented in a training dataset 230. For example, content generated by an enterprise and/or brand that is representative or otherwise embodies a particular tone and/or style is used to generate the training dataset 230. In various embodiments, the training dataset 230 includes structured data that associates values (e.g., text segments) with a particular schema, role, and/or attribute. For example, the training dataset 230 includes key-value store. Continuing this example, in the case of email content, the training dataset 230 associates components of the email (e.g., header, preheader, body, call to action, etc.) with corresponding text segments extracted or otherwise obtained from emails.

In various embodiments, the training dataset 230 is used to train a pre-trained machine learning model 226A. In one example, the pre-trained machine learning model 226A is trained, during a training operation 216, using a self-supervised training method such as fine-tuning the pre-trained machine learning model 226A in order to modify the parameters of the pre-trained machine learning model 226A. In various other embodiments, the training operation 216 is performed to modify the pre-trained machine learning model 226A based on the training dataset 230. For example, the parameters and/or weights of the pre-trained machine learning model 226A are modified using various training operations 216 such as transfer learning, domain adaptation, few-shot learning, prompt engineering, LoRA, and/or other techniques.

In various embodiments, a LoRA is used during the training operation 216 to generate a model weight delta 224. For example, the model weight delta 224 represents changes and/or modifications to the parameters and/or weights of the pre-trained machine learning model 226A. Continuing this example, the model weight delta 224 includes the delta of the values of the pre-trained machine learning model 226A parameters. Furthermore, in an embodiment, the model weight delta 224 is used during a merging operation 214 to generate the adapted machine learning model 226B. For example, a different version of the pre-trained machine learning model 226A is merged with the LoRA generated during the training operation to generate the adapted machine learning model 226B. In an embodiment, the adapted machine learning model 226B includes an IFT version of the pre-trained machine learning model 226A.

In an embodiment, a prompt 228 is provided to the adapted machine learning model 226B, and the output 208 is generated using guided decoding 232. In one example, the prompt 228 includes a request to generate content. In various embodiments, the adapted machine learning model 226B generates content (e.g., text) that matches the tone included in the training dataset 230. For example, the adapted machine learning model 226B generates content, based on a data format indicated during guided decoding 232, that matches the tone of a particular brand.

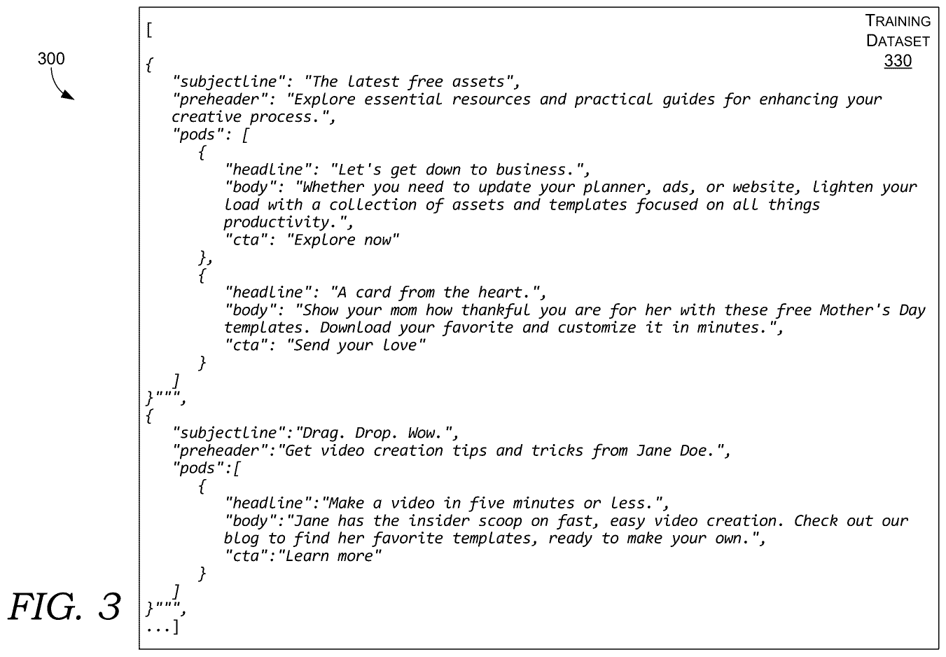

FIG. 3 is an example data structure 300 that includes a training dataset 330 for training an adapted machine learning model, in accordance with an embodiment. In various embodiments, the data structure 300 includes a structured data object (e.g., JSON) that associates a component of content to the corresponding value. For example, the content includes curated text data such as emails, marketing materials, educational materials, or other text generated to have a specific tone. As illustrated in the example in FIG. 3, the “subjectline” is associated with a particular text segment extracted from content (e.g., “latest free assets” and “Drag. Drop. Wow.”). In various embodiments, the data structure 300 associates attributes and/or roles with text of the content. For example, a particular role and/or attribute of text includes a “call to action,” where the corresponding text has a purpose and/or intended goal. Continuing this example, the text “Explore now” corresponds to a call to action with the intended goal and/or purpose of getting the reader to perform some action (e.g., explore new assets).

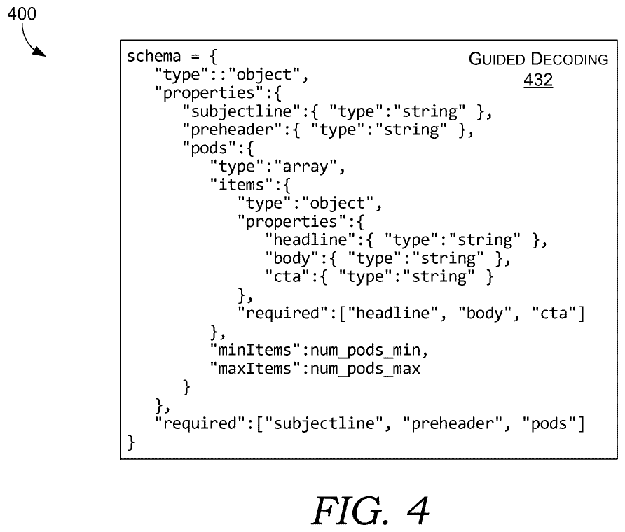

Turning now to FIG. 4, FIG. 4 is an example data schema used during guided decoding 432 with an adapted machine learning model, in accordance with an embodiment. In various embodiments, as described above, the adapted machine learning model is trained to generate content (e.g., text) that includes a particular tone. Furthermore, in such embodiments, guided decoding 432 is used to generate content in a particular format. In the example illustrated in FIG. 4, guided decoding 432 defines a schema for generating an email. In various embodiments, guided decoding 432 adds constraints to the decoding process of the adapted machine learning model and causes the adapted machine learning model to generate text that adheres to the schema and/or other requirements. Furthermore, in some embodiments, guided decoding 432 includes dynamic adjustment of intermediate outputs generated by the adapted machine learning model, a reward function to prioritize certain types of outputs, and/or the combining of the outputs of multiple machine learning models.

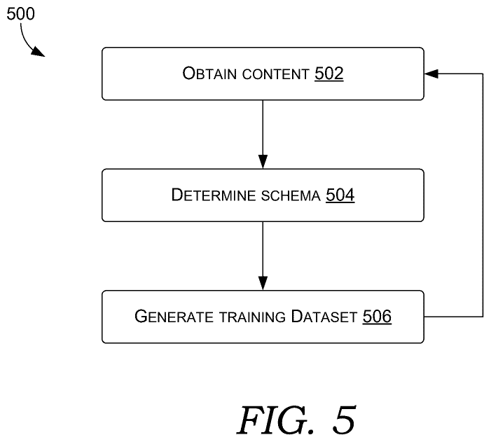

FIG. 5 is a flow diagram showing a method 500 for generating a training data in accordance with at least one embodiment. The method 500 can be performed, for instance, by the tone-adapted machine learning model tool 104 of FIG. 1. Each block of the method 500, 600, 700, and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, the system implementing the method 500 obtains content. As described above in connection with FIG. 1, in various embodiments, the content includes brand- and/or enterprise-generated content (e.g., text) that includes or otherwise embodies a tone associated with the brand and/or enterprise. For example, content such as marketing material, training documents, service responses, documentation, and/or other text generated by copywriters, employees, and/or individuals associated with a brand and/or enterprise are written to include the tone associated with an identity of the brand and/or enterprise. As such, in various embodiments, representative content of the tone associated with the identity is collected or otherwise obtained as training data. For example, an engineer selects content to include in the training data.

At block 504, the system implementing the method 500 determines a schema associated with the content. For example, the schema represents roles, attributes, components, purpose, and/or other information about the text that is relevant to adapting a machine learning model to generate content associated with the tone and/or identity of the brand and/or enterprise. At block 506, the system implementing the method 500 generates a training dataset. For example, the system implementing the method 500 generates key-value pairs, where the keys indicate the schema (e.g., roles, attributes, components, purpose, etc.), and the values include the corresponding text.

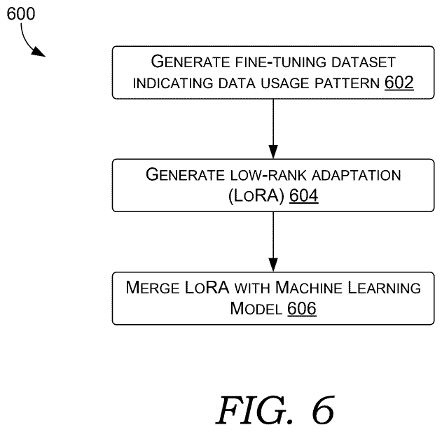

FIG. 6 is a flow diagram showing a method 600 for training a tone-adapted machine learning model in accordance with an embodiment. As shown at block 602, the system implementing the method 600 generates a fine-tuning dataset that indicates data usage patterns. For example, the system implementing the method 600 generates a training dataset as described above in connection with FIG. 5. In another example, the fine-tuning dataset includes content that includes and/or is representative of the tone that the tone-adapted machine learning model is to mimic.

At block 604, the system implementing the method 600 generates the LoRA by at least fine-tuning a machine learning model. For example, a pre-trained machine learning model is fine-tuned using gradient descent in a self-supervised manner to update the state of the pre-trained machine learning model. At block 606, the LoRA is merged with a machine learning model to generate the tone-adapted machine learning model. Continuing the example above, an IFT machine learning model of the same base model as the pre-trained machine learning model (such that the model parameters are the same) is merged with the LoRA to modify the parameters of the IFT machine learning model.

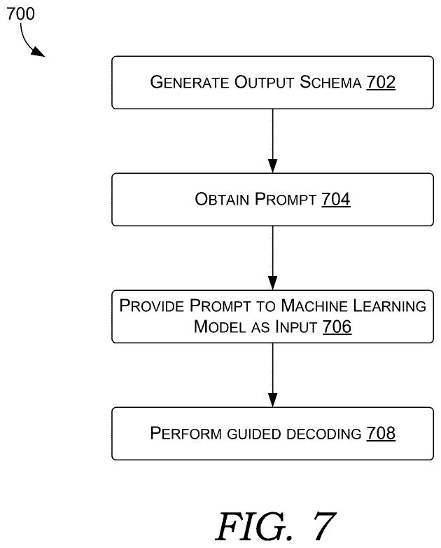

FIG. 7 is a flow diagram showing a method 700 for generating content using a tone-adapted machine learning model in accordance with an embodiment. As shown at block 702, the system implementing the method 700 generates an output schema. In one example, the output of the tone-adapted machine learning model is an email, and a schema represents the components of an email (e.g., body, header, subject line, etc.) and corresponding values and/or data type (string, email address, etc.). In another example, the output of the tone-adapted machine learning model includes product documentation and the schema defines various component of the documentation.

At block 704, the system implementing the method 700 obtains a prompt. For example, a user prompts the tone-adapted machine learning model to generate a marketing email or other content. At block 706, the system implementing the method 700 provides the prompt to the tone-adapted machine learning model. In one example, the prompt is modified to provide additional instructions to the tone-adapted machine learning model. In an embodiment, prompt engineering or similar techniques are used to improve the output generated based on the prompt. At block 708, the system implementing method 700 performs guided decoding using the output schema. Returning to the example above, the tone-adapted machine learning model generates an email based on the defined schema indicating the components of the email.

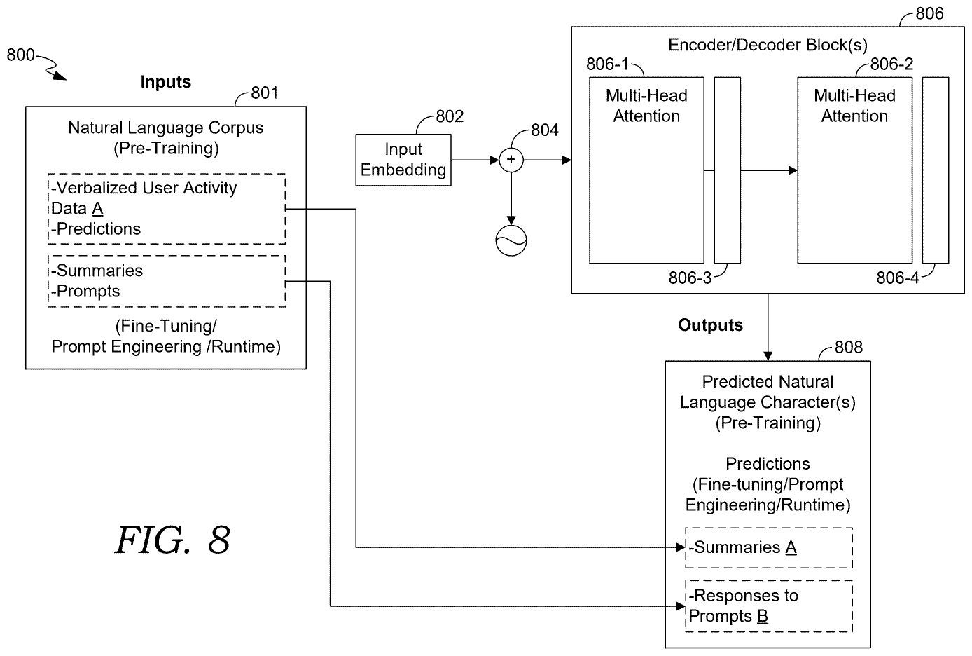

FIG. 8 is a block diagram of a Large Language Model 800 (e.g., a BERT model or GPT-4 model) that uses particular inputs to make particular predictions (e.g., answers to questions), according to some embodiments. In some embodiments, this model 800 represents or includes the functionality as described with respect to the machine learning model 126 and/or the tone-adapted machine learning model tool 104 of FIG. 1. In various embodiments, the language model 800 includes one or more encoders and/or decoder blocks 806 (or any transformer or portion thereof).

First, a natural language corpus (e.g., various WIKIPEDIA English words or BooksCorpus) of the inputs 801 are converted into tokens and then feature vectors and embedded into an input embedding 802 to derive meaning of individual natural language words (for example, English semantics) during pre-training. In some embodiments, to understand English language, corpus documents, such as text books, periodicals, blogs, social media feeds, and the like are ingested by the language model 800.

In some embodiments, each word or character in the input(s) 801 is mapped into the input embedding 802 in parallel or at the same time, unlike existing long short-term memory (LSTM) models, for example. The input embedding 802 maps a word to a feature vector representing the word. But the same word (for example, “apple”) in different sentences may have different meanings (for example, brand versus fruit). This is why a positional encoder 804 can be implemented. A positional encoder 804 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector as follows:

PE_{(pos,2i)}=sin(pos/10000^{2i/d}^{_{model}})

PE_{(pos,2i+1)}=cos(pos/10000^{2i/d}^{_{model}})

After passing the input(s) 801 through the input embedding 802 and applying the positional encoder 804, the output is a word embedding feature vector, which encodes positional information or context based on the positional encoder 804. These word embedding feature vectors are then passed to the encoder and/or decoder block(s) 806, where they go through a multi-head attention layer 806-1 and a feedforward layer 806-2. The multi-head attention layer 806-1 is generally responsible for focusing or processing certain parts of the feature vectors representing specific portions of the input(s) 801 by generating attention vectors. For example, in Question Answering systems, the multi-head attention layer 806-1 determines how relevant the i^{th} word (or particular word in a sentence) is for answering the question or its relevance to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following formula:

$$Z = softmax ( \frac{Q \cdot {K}^{T}}{\sqrt{Dimension of vector Q , K , or V}} ) \cdot V$$

For multi-headed attention, there are multiple weight matrices W^{q}, W^{k}, and W^{v} so there are multiple attention vectors Z for every word. However, a neural network may only expect one attention vector per word. Accordingly, another weighted matrix, W^{z}, is used to make sure the output is still an attention vector per word. In some embodiments, after the layers 806-1 and 806-2, there is some form of normalization (for example, batch normalization and/or layer normalization) performed to smoothen out the loss surface, making it easier to optimize while using larger learning rates.

Layers 806-3 and 806-4 represent residual connection and/or normalization layers where normalization recenters and rescales or normalizes the data across the feature dimensions. The feedforward layer 806-2 is a feedforward neural network that is applied to every one of the attention vectors outputted by the multi-head attention layer 806-1. The feedforward layer 806-2 transforms the attention vectors into a form that can be processed by the next encoder block or that can be used to make a prediction at 808. For example, given that a document includes first natural language sequence “the due date is . . . ” the encoder/decoder block(s) 806 predicts that the next natural language sequence will be a specific date or particular words based on past documents that include language identical or similar to the first natural language sequence.

In some embodiments, the encoder/decoder block(s) 806 includes pre-training to learn language (pre-training) and make corresponding predictions. In some embodiments, there is no fine-tuning because some embodiments perform prompt engineering, prompt tuning, or zero-shot learning. “Prompt engineering” refers to a process of designing or using structured input to the model (referred to as a prompt or prompts) to cause a desired response to be generated by the model. In some embodiments, prompt engineering includes creating the best or optimal prompt, or series of prompts, for the desired user task or output. Accordingly, given a first prompt (which may include target content), if the model produces a first output with a high likelihood of not being the correct response, particular embodiments learn such that a second output (indicative of a high likelihood of being a correct response) is always produced when such a first prompt is provided as input. In this way, at model deployment time, no output is ever produced with a low likelihood of being the correct response if the first prompt (or variation thereof) is provided, thereby increasing the accuracy of the model's generative outputs.

Pre-training is performed to understand language, and fine-tuning is performed to learn a specific task, such as learning an answer to a set of questions (in Question Answering systems). In some embodiments, the encoder/decoder block(s) 806 learns what language and context are for a word in pre-training by training on two unsupervised tasks (MLM and NSP) simultaneously or at the same time. In terms of the inputs and outputs, at pre-training, the natural language corpus of the inputs 801 may be various historical documents, such as text books, journals, and periodicals, in order to output the predicted natural language characters in 808 (not make the predictions at runtime or prompt engineering at this point). The encoder/decoder block(s) 806 takes in a sentence, paragraph, or sequence (for example, included in the input[s] 801), with random words being replaced with masks. The goal is to output the value or meaning of the masked tokens. For example, if a line reads, “please [MASK] this document promptly,” the prediction for the “mask” value is “send.” This helps the encoder/decoder block(s) 806 understand the bidirectional context in a sentence, paragraph, or line at a document. In the case of NSP, the encoder/decoder block(s) 806 takes, as input, two or more elements, such as sentences, lines, or paragraphs, and determines, for example, if a second sentence in a document actually follows (for example, is directly below) a first sentence in the document. This helps the encoder/decoder block(s) 806 understand the context across all the elements of a document, not just within a single element. Using both of these together, the encoder/decoder block(s) 806 derives a good understanding of natural language.

In some embodiments, during pre-training, the input to the encoder/decoder block(s) 806 is a set (for example, 2) of masked sentences (sentences for which there are one or more masks), which could alternatively be partial strings or paragraphs. In some embodiments, each word is represented as a token, and some of the tokens are masked. Each token is then converted into a word embedding (for example, 802). At the output side is the binary output for the next sentence prediction. For example, this component may output 1, for example, if masked sentence 2 followed (for example, was directly beneath) masked sentence 1. The output is word feature vectors that correspond to the outputs for the machine learning model functionality. Thus, the number of word feature vectors that are input is the same number of word feature vectors that are output.

In some embodiments, the initial embedding (for example, the input embedding 802) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence number (that includes the input(s) 801) that is encoded into a vector (for example, first sentence, second sentence, etc., assuming a top-down and right-to-left approach). The position embeddings are vectors that represent the position of a particular word in such a sentence that can be produced by positional encoder 804. When these three embeddings are added or concatenated together, an embedding vector is generated that is used as input into the encoder/decoder block(s) 806. The segment and position embeddings are used for temporal ordering since all of the vectors are fed into the encoder/decoder block(s) 806 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, once pre-training is performed, the encoder/decoder block(s) 806 performs prompt engineering or fine-tuning on a variety of datasets by converting different formats into a unified sequence-to-sequence format. For example, some embodiments perform the task by adding a new question answering head or encoder/decoder block, just the way a masked language model head is added (in pre-training) for performing an MLM task, except that the task is a part of prompt engineering or fine-tuning. This includes the encoder/decoder block(s) 806 processing the inputs 801 (i.e., the verbalized user activity data, the predictions, summaries, and/or prompts) in order to make the predictions and confidence scores as indicated in 808. Prompt engineering, in some embodiments, is the process of crafting and optimizing text prompts for language models to achieve desired outputs. In other words, prompt engineering is the process of mapping prompts (e.g., a question) to the output (e.g., an answer) that it belongs to for training. For example, if a user asks a model to generate a poem about a person fishing on a lake, the expectation is that it will generate a different poem each time. Users may then label the output or answers from best to worst. Such labels are input to the model to make sure the model is giving more human-like or best answers, while trying to minimize the worst answers (e.g., via reinforcement learning). In some embodiments, a “prompt” as described herein includes one or more of: a request (e.g., a question or instruction [e.g., write a poem]), target content, a command or instruction, and/or more examples (e.g., one-shot or two-shot examples).

In an illustrative example, in some embodiments, the predictions of the output 808 may be generative text, chart, graphs, or other visualizations, such as those described above with FIGS. 1 and 2. Alternative to prompt engineering or fine-tuning, in some embodiments the inputs 801 and outputs 808 represent “runtime” inputs and outputs. Runtime represents a time after which the model 700 has been trained (e.g., via pre-training and/or fine-tuning and/or prompt engineering), tested, and deployed.

An artificial intelligence (AI) system refers to an artificial intelligence computing environment or architecture that includes the infrastructure and components that support the development, training, and deployment of artificial intelligence models. It provides necessary hardware, software, and frameworks for developers to create and run artificial intelligence applications. An artificial intelligence system may be a cloud-based AI solution that leverages cloud computing infrastructure to develop, train, deploy, and manage AI models and applications. AI models may specifically refer to generative AI models that are designed to generate new data or content that is similar to, or in some cases, entirely different from data they are trained on.

Artificial intelligence systems can include transformer models that are capable of running complex neural language processing tasks. Transformer models—also known as Large Language Models (LLMs)—have applications in a wide range of industries. An LLM is a trained deep learning model that can recognize, summarize, translate, predict, and generate content using very large datasets. LLMs and other types of generative AI models are associated with a training phase—where a model is taught to learn patterns, relationships, and knowledge from training datasets—and an inference phase, which includes making predictions, classifications, or generating outputs for real-world tasks or queries.

Unlike convolutional neural networks (CNNs), which are typically used for image tasks and mostly rely on convolution operations, transformer models are based on simple general matrix multiplication (GEMM) tasks, which can be further broken down to perform a dot product operation on two vectors. While CNN architectures are typically computationally heavy with a relatively small number of parameters, the architecture of transformer models results in the opposite: a very large number of parameters, with a fairly small number of operations. The LLM architecture can create challenges in that performance bottlenecks reside in the memory throughput and capacity rather than the compute engine.

Transformer models operate with memory accesses to retrieve a matrix of weights out of memory, along with a vector (either the input vector or partial result from a previous stage of the model), and multiplying the two. This is true for the model's attention sublayers, the FFN (feedforward network), sublayers, and for the final embedding layer. As vector-matrix multiplication is actually comprised of numerous vector-vector multiplications (dot product), it is fair to say that most memory accesses are used to read two vectors in order to perform a dot product on them. As such, reading out the full vectors is inefficient.

As such, transformer models (also referred to herein as “generative AI models”) require computational resources including processors and memory for the training phase and inference phase. The generative AI models operate with different types of processors (e.g., central processing units [CPUs] or graphics processing unit [GPUs]) in architectures that include multi-core CPUs or parallel processors including GPUs and tensor processing units (TPUs). Memory can be used to store model parameters and intermediate data for the training phase and the inference phase. Memory requirements may depend on the size and the architecture of the generative AI models. By way of illustration, an LLM can support an inferencing phase that includes using a trained model to make predictions, draw conclusions, or generate output based on input data or patterns learned during the model's training phase. During the inference phase, an LLM can use DRAM (Dynamic Random-Access Memory) to store various components and data for making inferences. LLMs can store their pre-trained model parameters (e.g., weights and biases of the neural network layers) in DRAM, and when a new input is provided for inference, the model accesses these parameters from DRAM to make predictions.

The inference phase can be divided into two stages: a prompt stage and an auto-regressive stage. The prompt stage can include receiving and processing input as a batch of new tokens as part of the same inference. The prompt stage may operate based on a Key-Value (KV) cache technique, where a KV cache is created for tokens in a batch. During the prompt stage, the input is being digested. The auto-regressive state can include using the model to generate the tokens one by one, based on previous tokens, relying on reading the KV cache of previously processed tokens, and adding the data of only new tokens to the KV cache. This auto-regressive stage includes the model generating a response to the input from the prompt stage.

Having described embodiments of the present disclosure, FIG. 9 provides an example of a computing device in which embodiments of the present disclosure may be employed. Computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 9 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 9 and make reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, Random Access Memory (RAM), Read-Only Memory (ROM), Electrically Erasable Programmable Read-Only Memory (EEPROM), flash memory or other memory technology, Compact Disk (CD)-ROM, digital versatile disks (DVDs) or other optical disk storage, magnetic cassettes, magnetic tape, magnetic disk storage or other magnetic storage devices, or any other medium that can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, infrared, and other wireless media. Combinations of any of the above should also be included within the scope of computer-readable media.

Memory 912 includes computer storage media in the form of volatile and/or nonvolatile memory. As depicted, memory 912 includes instructions 924. Instructions 924, when executed by processor(s) 914 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built-in. Illustrative components include a microphone, joystick, game pad, satellite dish, scanner, printer, wireless device, etc. I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 900. Computing device 900 may be equipped with depth cameras, such as stereoscopic camera systems, infrared camera systems, camera systems, and combinations of these, for gesture detection and recognition. Additionally, computing device 900 may be equipped with accelerometers or gyroscopes that enable detection of motion. The output of the accelerometers or gyroscopes may be provided to the display of computing device 900 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C), or (A, B, and C).”

What is claimed is:

1. A method comprising:
obtaining content including text representing a tone;
generating a training dataset including keys associated with attributes of the tone and text segments of the content corresponding to the attributes;
generating a low-rank adaptation (LoRA) by at least fine-tuning a pre-trained machine learning model based on the training dataset; and
merging the LoRA with an instruction fine-tuned machine learning model to generate a tone-adapted machine learning model.

2. The method of claim 1, wherein the content includes a marketing campaign produced by a brand and includes the tone that is associated with an identity of the brand.

3. The method of claim 2, wherein the marketing campaign includes emails, and the keys correspond to components of the emails.

4. The method of claim 3, wherein the output schema defines an email format for the output corresponding to the emails.

5. The method of claim 1, wherein the method further comprises:
generating an output schema;
obtaining a prompt; and
causing the tone-adapted machine learning model to generate an output based on the prompt by performing guided decoding based on the output schema.

6. The method of claim 1, wherein the prompt is obtained through an artificial intelligence assistant of an application.

7. The method of claim 1, wherein obtaining content further comprises obtaining textual data generated to include a particular identity.

8. A non-transitory computer-readable medium storing executable instructions embodied thereon, that, as a result of being executed by a processing device, cause the processing device to perform operations comprising:
generating a training dataset including text that represents a tone associated with a brand identity;
fine-tuning a pre-trained machine learning model based on the training dataset; and
merging the pre-trained machine learning model with an instruction fine-tuned machine learning model to modify parameters of the instruction fine-tuned machine learning model to generate a tone-adapted machine learning model.

9. The medium of claim 8, wherein merging the pre-trained machine learning model with the instruction fine-tuned machine learning model further comprises applying a low-rank adaptation to the instruction fine-tuned machine learning model.

10. The medium of claim 8, wherein the operations further comprises:
obtaining a prompt; and
causing the tone-adapted machine learning model to generate an output that mimics the tone associated with the brand identity based on the prompt.

11. The medium of claim 10, wherein causing the tone-adapted machine learning model to generate the output further comprises performing guided decoding based on a schema to generate the output.

12. The medium of claim 11, wherein the schema defines a format of the output and a data type associated with tokens of the output.

13. The medium of claim 12, wherein the guided decoding causes at least one intermediate token generated by the tone-adapted machine learning model to be modified in the output.

14. The medium of claim 10, wherein the operations further comprise obtaining a second prompt to refine the output generated by the tone-adapted machine learning model.

15. The medium of claim 14, wherein the operations further comprise causing the tone-adapted machine learning model to generate a second output based on the second prompt.

16. An AI-based system, comprising:
a tone-adapted machine learning model tool having:
a training dataset generated by at least:
obtaining textual data that includes a tone associated with an entity;
generating, based on a schema, a set of key-value pairs that associates attributes of the tone with text segments of the textual data;
a tone-adapted machine learning model trained by at least:
training a first machine learning model based on the training dataset; and
merging the first machine learning model with a second machine learning model to modify a state of the second machine learning model to generate the tone-adapted machine learning model; and
an interface element that obtains a user prompt to the tone-adapted machine learning model through a user interface of an application.

17. The system of claim 16, wherein the attributes of the tone include at least one of: manner of speech, word choice, style, sentiment, voice, and verbiage.

18. The system of claim 16, wherein the tone-adapted machine learning model generates content by at least:
obtaining, as an input, the prompt to generate the content that includes the tone; and
causing the tone-adapted machine learning model to generate an output based on the prompt.

19. The system of claim 16, wherein the entity includes at least one of: a brand, an enterprise, an author, and a writing style.

20. The system of claim 16, wherein merging the first machine learning model with the second machine learning model further comprises merging the second machine learning model with the low-rank adaptation generate by at least training the first machine learning model based on the training dataset.
